(19) United States
(12) Patent Application Publication
(10) Pub. No.: US 2011/0251921 A1
(43) Pub. Date: Oct. 13, 2011

(54) METHOD AND SYSTEM TO FACILITATE BILLING OF EMBEDDED APPLICATIONS IN A SERVING PLATFORM

(75) Inventors: Farhang Kassaei, San Jose, CA (US); Sharon Beloli, Santa Clara, CA (US)

(73) Assignee: eBay Inc., San Jose, CA (US)

(21) Appl. No.: 12/874,017

(22) Filed: Sep. 1, 2010

Related U.S. Application Data
(60) Provisional application No. 61/322,685, filed on Apr. 9, 2010.

(51) Int. Cl. G06Q 30/00

(52) U.S. Cl. 705/26.41

(57) ABSTRACT

Various embodiments described herein include one or more of systems, software, and methods to automatically facilitate a billing transaction between a third-party developer and a user subscribing to a third-party application. Some such embodiments create a sub-account under a serving platform account registered to the user. Some embodiments include storing a billing plan associated with the third-party application, the billing plan defining a fee to subscribe to the third-party application.

### RELATED APPLICATIONS

This application claims the priority benefit of U.S. Provisional Application No. 61/322,685, filed Apr. 9, 2010, which is incorporated herein by reference.

### TECHNICAL FIELD

This application relates generally to the field of electronic-based commerce.

### BACKGROUND

With the widespread acceptance of the Internet as an interactive communication medium, deploying applications that run on a common platform has increased in popularity. For example, an online marketplace may deploy, within the common platform, an application to manage a high volume of sales within the marketplace. Some of these applications are provided by the marketplace itself, whereas others are written and sold by third-party software developers. In order to subscribe to these applications, especially third-party applications, subscribers typically have to search the Internet for the applications. To receive revenue for the use of the application, the developer of the third-party application usually must provide a billing system to properly authenticate, record, and process billing transactions (e.g., subscribing to or purchasing the application). As a result, subscribers may potentially interact with a number of different billing systems when purchasing from more than one developer.

Furthermore, subscriptions to these third-party applications are handled outside of the online marketplace (e.g., a web platform marketplace), and some sellers may not trust third-parties (e.g., the third-party software developers) with payment details.

### BRIEF DESCRIPTION OF DRAWINGS

Embodiments of the present invention are illustrated by way of example and not limitation in the figures of the accompanying drawings, in which like reference numbers indicate similar elements.

FIG. 1 is a block diagram of a system within which a method and system to facilitate billing of embedded applications in a serving platform may be implemented, according to an example embodiment.

FIG. 2 is a block diagram illustrating modules of an application marketplace platform, according to an example embodiment.

FIG. 3 is a block diagram illustrating an example data structure representing a billing plan, according to an example embodiment.

FIG. 4 is a state diagram illustrating a lifecycle of a billing plan, according to an example embodiment.

FIG. 5 is a flow chart illustrating a method for charging a user for a third-party application provided by the application serving platform, according to an example embodiment.

FIG. 6 is a block diagram illustrating an example structure of a user account, according to an example embodiment.

FIG. 7 is a message diagram illustrating messages involved in billing a subscriber, according to various example embodiments.

FIG. 8 is an alternative message diagram illustrating messages involved in billing a subscriber, according to various example embodiments.

FIG. 9 is a further alternative message diagram illustrating messages involved in billing a subscriber, according to various example embodiments.

FIG. 10 is a diagrammatic representation of a machine in the example form of a computer system within which set instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details. Further, well-known instruction instances, protocols, structures, and techniques have not been shown in detail.

An application marketplace platform is a framework that enables third-party applications to offer custom functionality and tools within a serving platform (e.g., an e-commerce marketplace). Rather than taking users away from the serving platform to access these tools, the serving platform enables third-party developers to contribute to the serving platform in a controlled and consistent manner. This effort enables the serving platform to leverage the strengths of the developer community to enhance the buying and selling experience on the serving platform.

As users of the serving platform scale, they may be able to add applications to their existing tool set without the need to migrate to a completely different environment or serving platform. To illustrate, a user initially may sell a small number of items on a serving platform. At this point in time, the user may be viewed by the serving platform as a casual seller. Over time, the user may become increasingly popular within the serving platform, such that the user is completing a large number of transactions every month. At this point in time, the user may be viewed by the serving platform as a power seller. As such, the user may benefit from an inventory management application. An application marketplace platform that, in this case, provides an inventory management application, benefits the user by providing tools that support the user in growing their presence within the serving platform.

For third-party developers, the application marketplace platform relieves the burden of a significant development task for the third-party developer by providing, among other things, billing and payment facilitates. The billing facilities are integrated into the application marketplace platform, thus providing a flexible approach of generating fees based, in part, on functionality provided by the serving platform.

A billing plan generally refers to one or more fees associated with a third-party application deployed by the application marketplace platform. In an example embodiment, a third-party developer defines the billing plan for the third-party application and submits the billing plan to the application marketplace platform. In some example embodiments, the third-party developer may submit one or more billing plans for a particular application. In other embodiments, a billing plan may be partitioned to define multiple fee plans, depending on any number of factors, including, for example, the status of the purchasing user within the serving platform.

After the third-party developer submits the billing plan to the application marketplace platform, the application marketplace platform makes at least some portion of the billing plan viewable to users interested in purchasing the third-party application. In an example embodiment, a user agrees to the fees described by the billing plan at the time the user subscribes to the third-party application.

Further details regarding the various example embodiments described above will now be discussed with reference to the figures accompanying the present specification. It should be noted that while example embodiments are discussed with respect to a marketplace and an application marketplace platform, embodiments may be applicable to non-marketplace environments (e.g., a publication system or a social networking system).

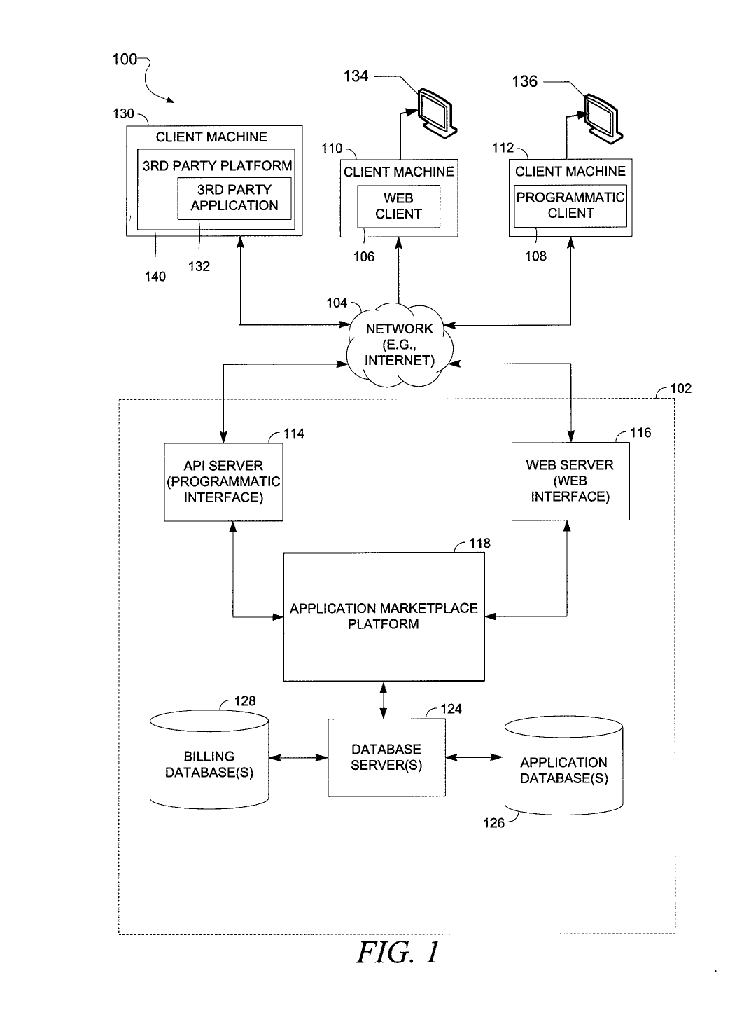

FIG. 1 is a network diagram depicting a client-server system 100, within which one example embodiment of facilitating billing of a third-party application deployed by a common platform. FIG. 1 shows basic relationships between the parts of the client-server system 100.

A serving platform (SP) 102, in the example, forms a network-based marketplace that provides server-side functionality, via a network 104 (e.g., the Internet or Wide Area Network (WAN)) to one or more client machines 110, 112, and 130. FIG. 1 illustrates, for example, a web client 106 (e.g., a browser, such as the INTERNET EXPLORER browser developed by MICROSOFT Corporation of Redmond, Wash. State), and a programmatic client 108 executing on respective client machines 110 and 112. The client machines 110 and 112 have associated display devices 134 and 136 (e.g., a monitor) for viewing data.

An application program interface (API) server 114 and a web server 116 are coupled to, and provide programmatic and web interfaces respectively to, an application marketplace platform 118. In turn, the application marketplace platform 118 is coupled to one or more databases (e.g., 126 and 128) via one or more database servers 124.

The application marketplace platform 118 integrates with a third-party platform 140 to deploy a third-party application 132 on the SP 102. In example embodiments, the third-party platform 140, third-party application 132, and the application marketplace platform 118 may implement or call standard, predefined interfaces. On the third-party side, the third-party application 132 may implement a participant interface implementation to provide an interface with the application marketplace platform 118. On the application marketplace side, the application marketplace platform 118 may implement an application integration services interface to provide platform functionality to the third-party application 132.

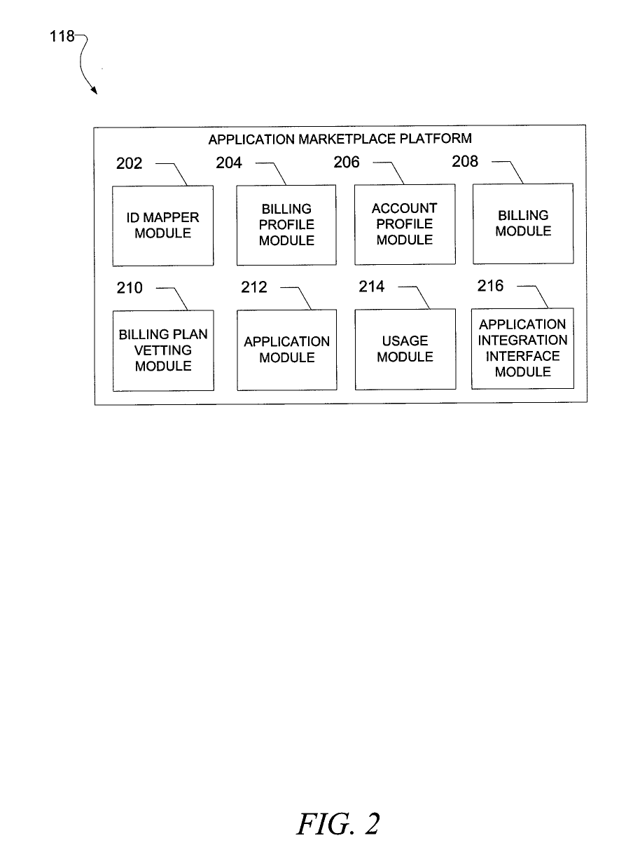

FIG. 2 is a block diagram illustrating modules of the application marketplace platform 118 used in facilitating billing of subscriptions to third-party applications, according to an example embodiment. The application marketplace platform 118 may comprise an ID mapper module 202, a billing profile module 204, an account profile module 206, a billing module 208, a billing plan vetting module 210, an application module 212, a usage module 214, and an application integration interface module 216. Further modules and components not necessary for functions of the example embodiment are not shown or described.

The ID mapper module 202 allows a flexible approach, for both the application marketplace platform 118 and third-party developers, to refer to billing plans stored by the application marketplace platform 118. As will be described in further detail below, the application marketplace platform 118 may refer to billing plans based on an assigned identifier created when the billing plan is submitted to the application marketplace platform 118. The ID mapper module 202 allows a third-party developer to specify an additional identifier that refers to the submitted billing plan. In this way, the application marketplace platform 118 may refer to the billing plan with the assigned identifier and the third-party developer may refer to the same billing plan with the specified identifier. As a result, third-party developers may more easily integrate existing billing systems with the application marketplace platform by allowing the third-party developers to maintain pre-existing identifiers used within systems outside of the application marketplace platform 118.

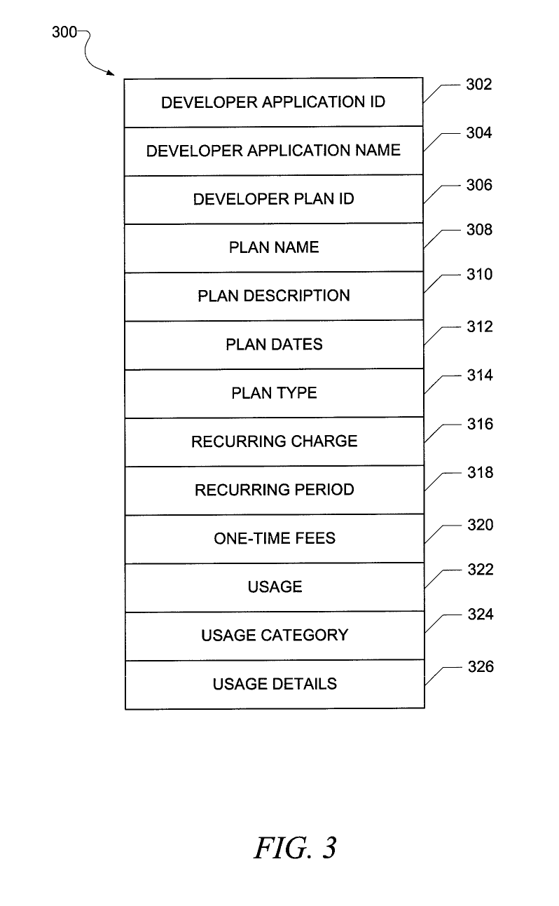

The billing profile module 204 receives and stores billing plans submitted by the third-party developers. The billing profile module 204 may reference the submitted billing plan based on the identifier either assigned by the billing profile module 204 or specified by the third-party developer. As will be further explained below (see, e.g., FIG. 3), a billing plan may include information describing various aspects related to a cost of a third-party application. For example, the billing plan may include an indication of whether a specific charge is a periodic charge or a one-time charge. Additionally, the billing plan may further include a cost to the charge (e.g., a transaction fee or service charge), as may be represented in various currencies. Still further, the billing plan may also describe charges for the subscriber's use of the third-party application, such as, for example, a fee for each query to a database.

The account profile module 206 manages user accounts related to subscriptions to third-party applications. When a user subscribes to a third-party application, the account profile module 206 will create an account specific to the subscribed third-party application. The created account holds billing information specific to the user and the third-party application. In example embodiments, each user (e.g., at the client machines 110 or 112) is registered to an account of the SP 102 that includes, for example, the user's personal information. When the user subscribes to a third-party application offered by the application marketplace platform 118, the account profile module 206 may create a sub-account under the account of the SP 102. The created sub-account may be specific to the subscribed third-party application. The sub-account may, in example embodiments, inherit the user's personal information associated with the account of the SP 102, as will be discussed below.

The billing module 208 facilitates periodic or triggered billing transactions between the user and the third-party developer as specified by a billing plan. For example, the billing plan may have a data field that includes a time component for periodic charges (e.g., 1-year subscription). When the user subscribes to a billing plan of a third-party application that includes such a data field, the billing module 208 may automatically trigger a billing transaction, to be stored by the account profile module 206, between the user and the third-party developer at each period specified by the billing plan.

The billing plan vetting module 210 confirms whether the submitted billing plan meets criteria defined by the application marketplace platform 118. As will be described in further detail below, once a third-party developer submits a billing plan, the billing plan vetting module 210 may authorize the billing plan (e.g., authorize use of the billing plan) if it meets determinable standards, as set forth by the application marketplace platform 118. For example, some example embodiments may allow a billing plan to provide textual fields that are displayable to users of the SP 102. To illustrate authorizing such a textual field, the application marketplace platform 118 may provide a policy that billing plans may not include obscene language. In this case, the billing plan vetting module 210 may authorize a billing plan if the billing plan vetting module 210 determines that the submitted billing plan does not include language considered to be obscene by the application marketplace platform 118, as specified by a configuration file accessible to administrators of the SP 102, for example.

The application module 212 receives and stores the third-party applications deployed by the application marketplace platform 118. The application module 212 may store the third-party applications in the application database 126.

The usage module 214 receives events related to usage-based billing. For example, a third-party application may report a usage event (e.g., login, database access, or any other application use) to the usage module 214. Responsive to receiving usage-based billing events, the usage module 214 records billing records in the third-party application specific account created by the account profile module 206.

The application integration interface module 216 is a programmable interface. A third-party platform, for example, invokes functionality provided by the application integration interface module 216 to provide functionality offered by the SP 102. For example, the SP 102 may provide functionality that returns a status of a user of the SP 102. The status may indicate whether the user is a high-volume seller or a low volume seller.

FIG. 3 is a diagram that shows an example data structure representing a billing plan 300. A third-party platform may submit the billing plan 300, or some portion thereof, to the application marketplace platform 118 to define a billing plan associated with the third-party application 132, both shown in FIG. 1.

A developer application identifier (ID) 302 identifies a developer of the third-party application. In some embodiments, the developer application ID 302 matches an identifier (ID) value assigned to the third-party application 132 when the third-party application 132 is initially submitted to the application marketplace platform 118.

A developer application name 304 is a textual representation of a name of the third-party application provided by the developer. The developer application name 304 may be shown in a billing statement to the subscriber.

A developer plan identifier (ID) 306 is a developer-assigned identifier that the application marketplace platform 118 may include in messages to the third-party platform (e.g., messages to notify the third-party platform of a new subscription). Plan name 308 and plan description 310 are display elements that provide human-readable information to the user regarding the billing plan. For example, the plan name 308 field may be included in the billing statement and show a name of the billing plan.

The plan description 310 is a human-readable textual field that describes the billing plan. In an example embodiment, the application marketplace platform 118 displays the plan description 310 to a user viewing the billing plan. This field allows the user to better understand the billing plan by providing a short description.

The plan dates field 312 represents a time frame that the billing plan is available for subscription. For example, the plan dates field 312 may indicate a start and end date that a user may subscribe to the billing plan. The application marketplace platform 118 may prohibit a user from subscribing until the current date is within the time range specified by the plan dates field 312.

A plan type field 314 identifies whether the billing plan is a billable plan or non-billable plan. That is, the developer may choose to indicate a free plan by setting the plan type field 314 to a value that indicates that the billing plan 300 is a non-billable plan, or may choose to indicate that the plan includes at least one charge by setting the plan type filed 314 to a value indicating that the billing plan 300 is a billable plan.

A recurring charge field 316 represents an amount of a recurring charge for usage of the third-party application 132. In some embodiments, the recurring charge field 316 may indicate a currency of the amount applied. A recurring period field 318 represents a period or frequency of the charge represented by the recurring charge field 316. In some embodiments, the recurring charge may indicate daily, weekly, bi-monthly, monthly, quarterly, bi-annually, annual charges, or any other periodic charge for usage of the third-party application 132.

A one-time fees field 320 may indicate that the billing plan has a one-time setup fee. The one-time fees field 320 may also indicate that the billing plan has a one-time fee that is charged once for the lifetime of the subscription.

A usage field 322 indicates whether the billing plan includes usage-based charges. If the usage field 322 indicates that the billing plan includes usage-based charges, a usage category field 324 and a usage details field 326 provide further information related to the usage-based charges. The usage category field 324 indicates which usage category types the third-party application uses. In some embodiments, the usage category field 324 may include multiple sub-fields. For example, the usage category field 324 may include a value indicating a subscription charge if the third-party application 132 sends the subscription fee charge (e.g., through the application integration services interface) rather than having the application marketplace platform 118 automatically charging the subscription fee to the third-party application specific account. As another example, the usage category field 324 may include a value indicating a plan usage charge if the third-party application 132 sends account activity usage records to the application marketplace platform 118. As a further example, the usage category field 324 may include a value indicating a non-plan usage charge if the third-party application 132 sends non-plan related account activity (e.g., in a online marketplace, postage fees) to the application marketplace platform 118.

The usage details field 326 provides one or more details about usage charges. In some embodiments, the usage details field 326 may include human readable descriptions that are intended to be displayed to the user prior to the user subscribing to the billing plan. The usage details field 326 may further include markup tags (e.g., <b>, <strong>, <em>, <i>, <u>, <ol>, <ul>, or other similar markup tags).

The order of the fields of the billing plan 300 can be varied as desired, as can the content of each field. FIG. 3 is intended only to be an example of one possible data structure; many other formats exist, as would be appreciated by those skilled in the art.

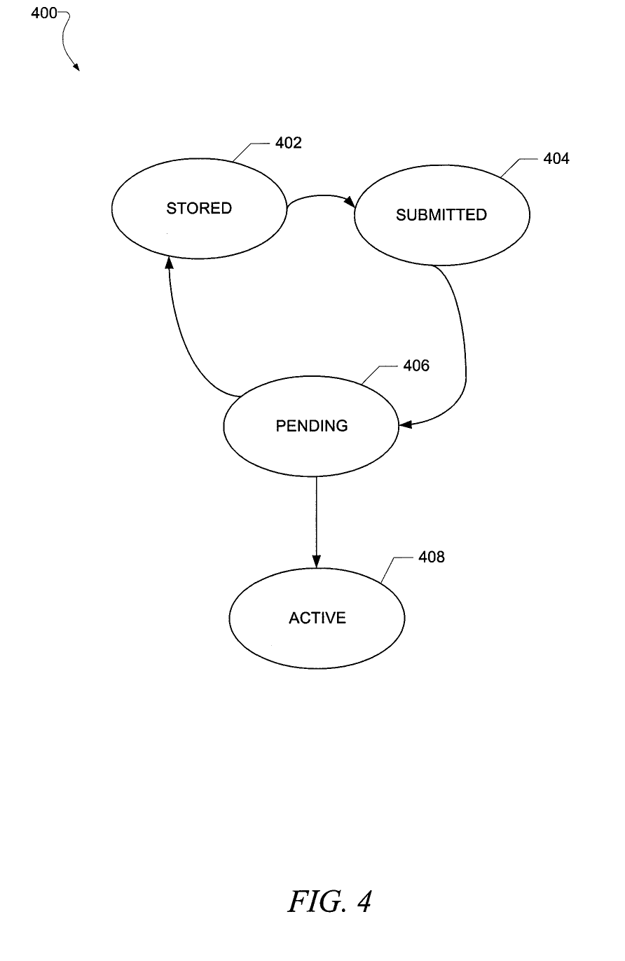

FIG. 4 is a state diagram illustrating a billing plan lifecycle 400 that is used to track the process of submitting a billing plan, configuring the billing plan, and enabling the billing plan for use by the users.

At operation 402, the application marketplace platform 118 of FIG. 1 receives a billing plan (e.g., billing plan 300 of FIG. 3) from a third-party application developer, also referred to as a developer. While the billing plan is in a stored state, the application marketplace platform 118 permits the developer to test (e.g., subscribe and use the application) and make changes to the billing plan in the subscription flow without being charged by the application marketplace platform 118. In an example embodiment, the application marketplace platform 118 does not create a billing record if the developer application ID 302 of FIG. 3 corresponds to the user subscribing to the billing plan.

The application marketplace platform 118 moves the billing plan 300 to a submitted state at operation 404 responsive to the developer requesting the application marketplace platform 118 to configure the billing plan 300 (e.g., for use with the third-party application 132). The application marketplace platform 118 prohibits the developer from modifying the billing plan while the billing plan is in the submitted state.

The billing plan remains in the submitted state until the application marketplace platform 118 changes the billing plan to a pending state in operation 406. This may occur, for example, upon commencement of configuration of the billing plan 300. While the billing plan is in the pending state, the billing plan vetting module 210 of FIG. 2 configures the billing plan stored in the billing profile module 204 of FIG. 2. In some example embodiments, the vetting module 210 of FIG. 2 configures the billing plan for use with the third-party application 132. As an example, if the billing plan vetting module 210 finds an error in the information provided by the developer, the application marketplace platform 118 notifies the developer and the billing plan is placed back in the stored state (e.g., operation 402) for the developer to edit. In an example embodiment, an employee of the marketplace manually reviews the submitted information. In another example embodiment, at least some portion of the review is performed automatically (e.g., by the application market platform 118). For example, the application marketplace platform 118 may parse the billing plan for objectionable language or according to predefined rules.

An active state applies to the billing plan after the billing plan vetting module 210 has configured the billing plan at operation 408. In some embodiments, users can or cannot see the plan based on a visibility setting (e.g., hidden or visible) and based on the plan's date range (e.g., start date and end date). The application marketplace platform 118 may set the visibility setting to “hidden” and may suggest to the developer to do a final verification. Once the developer is reasonably satisfied that the billing plan performs as expected, the developer may send a request (e.g., send a control input via a user interface) to the application marketplace platform 118 to set the plan to a “visible” state. The visible state allows other users to subscribe to the third-party application.

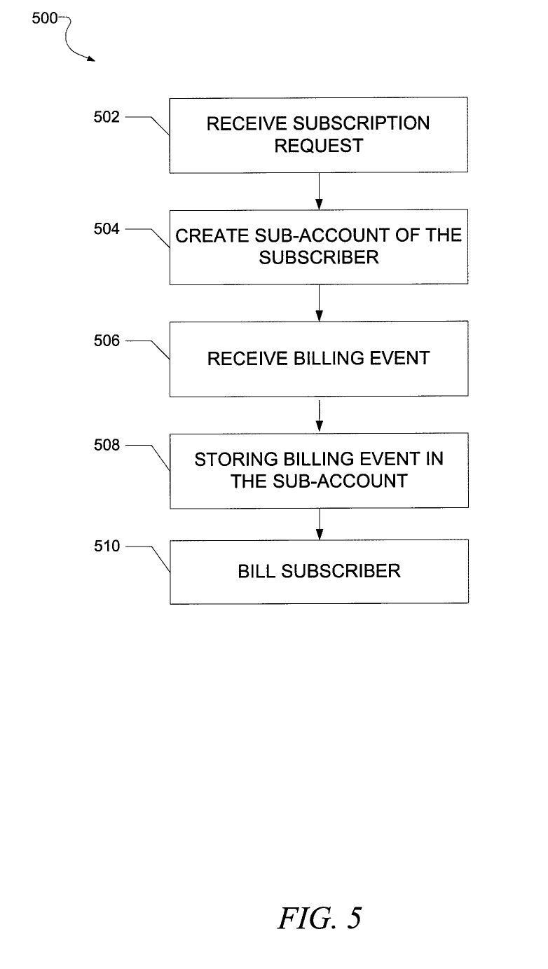

FIG. 5 is a flow chart showing a billing process 500, according to one example embodiment. At operation 502, the application marketplace platform 118 of FIG. 1 receives a subscription request from a user to subscribe to a third-party application, also referred to as a service.

At operation 504, the account profile module 206 of FIG. 2 creates a sub-account under a user-account of the user requesting the subscription.

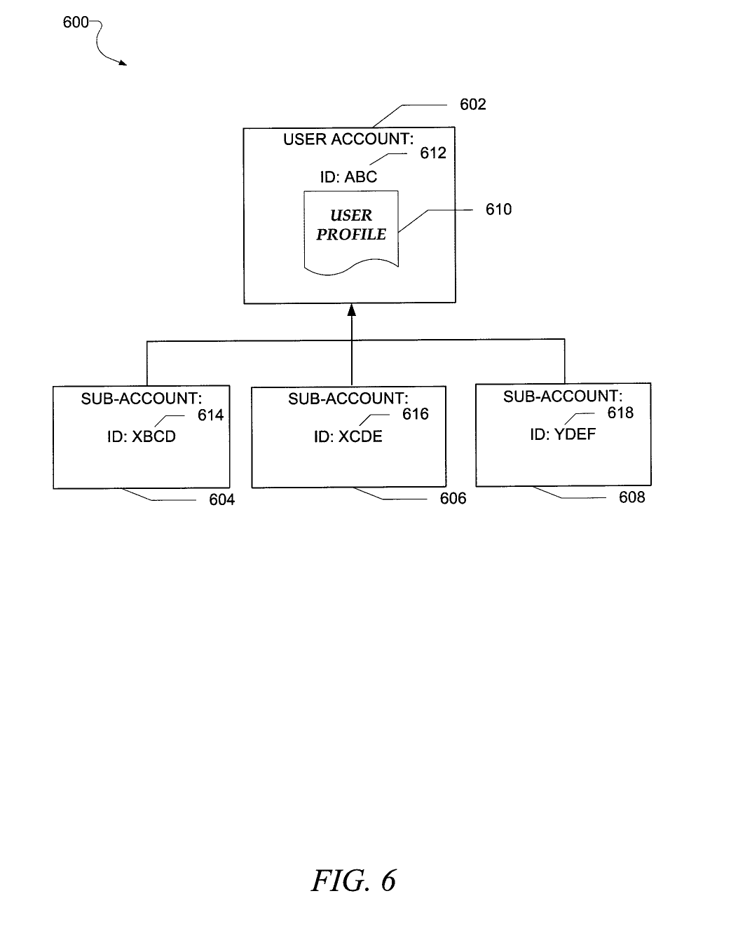

Switching focus for a moment to better describe the account structure of the user, FIG. 6 is a block diagram that illustrates an example structure 600 of a user account. FIG. 6 shows that a user-account 602 acts as a parent account for sub-accounts 604, 606, and 608. The user-account 602 is the user's account within the SP 102 (see FIG. 1). Typically, the user-account 602 includes a user profile 610 The user profile may 610 include personal information of the user, such as, for example, an email address, a physical mailing address, a user name (first and last names), a company name, a phone number, and other personal information. Responsive to a user subscribing to a third-party application from the application marketplace platform 118, the account profile module 206 (see FIG. 2) may extend the user-account 602 to have a third-party application accounts (also referred to as a sub-accounts) to store account information specific to the subscription and use of the third-party application. In some example embodiments, information in the user profile 610 may be pulled from the user-account 602 to the sub-account (e.g., 604) by the account profile module 206. In other embodiments, the sub-account includes the user profile 610 indirectly by reference, based on the child-parent relationship between the user-account 602 and sub accounts (e.g. 604, 606, and 608). For each new third-party application, the account profile module 206 creates a separate sub-account (e.g., 606 and 608) to hold account information of the user's subscription to the third-party application.

Each account (user-account and sub-account) may include a number of identifiers. The user-account 602 may be identified by any combination of, for example, a user identifier of the user within the SP 102, an account identifier assigned by the application marketplace, or a registration email address. In turn, the sub-accounts (e.g., 604, 606, and 608) may each be identified by an automatically generated identifier(s) (e.g., 614, 616, and 618, respectively) assigned by the application marketplace platform 118. In some embodiments, the generated identifier for the sub-account may indicate the third-party developer providing the application for subscription. For example, identifiers 614 and 616 include the prefix X, which may correspond to a particular third-party developer, while a Y prefix of identifier 618 may correspond to different third-party developer. The application marketplace platform 118 of FIG. 2 may automatically generate the third-party developer prefix identifiers.

With reference back to FIG. 5, operation 506 involves receiving a billing event from the third-party application. In an example embodiment, a third-party application can charge subscribers (e.g., cause subscribers to be charged) for usage and also for setup fees, one-time fees, and even recurring fees, by reporting these transactions to the billing module 208 (see FIG. 2). For recurring fees, sending a usage charge is an alternative to having the billing module 208 manage periodic charges on the third-party developer's behalf. To engage in usage-based billing, the billing profile module 204 of FIG. 2 receives the billing plan, submitted by a third-party developer, which defines usage based charges.

Operation 508 involves the application marketplace platform 118 of FIG. 2 storing the billing event in the sub-account created at operation 504. The billing event may explicitly define an amount the subscriber is to be charged (e.g., one time fees), as determined by the third-party application. Alternatively, a billing event may describe a billing event based on user's use of the application.

Operation 510 involves the application marketplace platform 118 billing the subscriber. In an example embodiment, usage-based fees are billed at the time the application marketplace platform 118 receives the billing event at operation 506. Alternatively, the application marketplace platform 118 may bill usage-based fees periodically according to the period defined by recurring period field 318 (with reference to FIG. 3). Example embodiments that bill usage-based fees at the beginning or end of the specified period may also bill recurring expenses based on the reoccurring period.

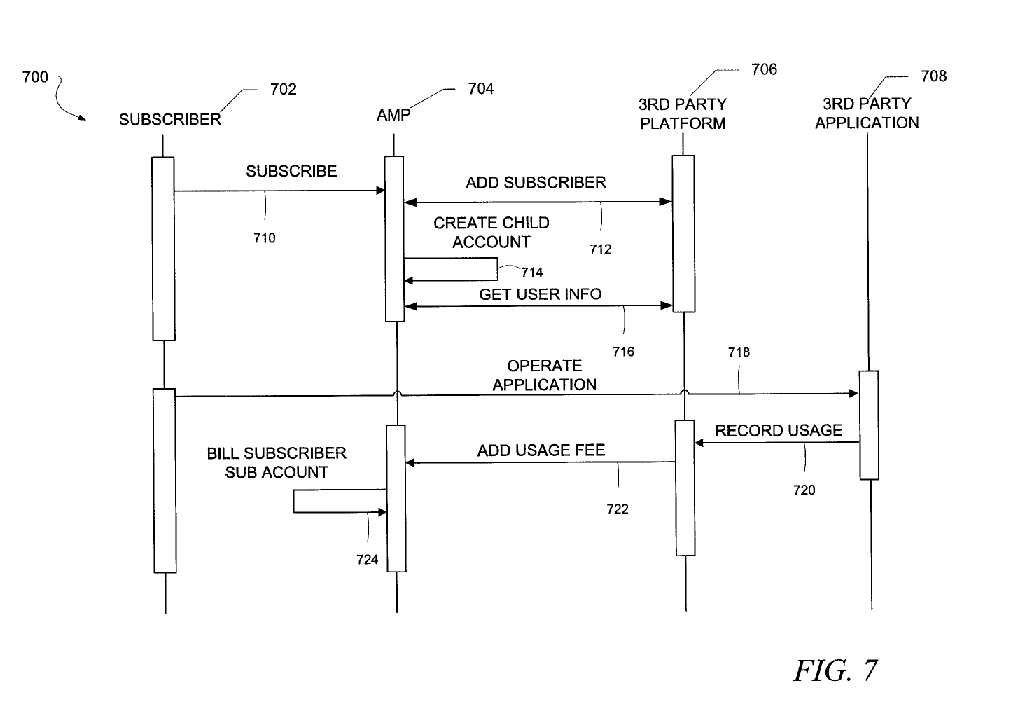

FIGS. 7-9 are message diagrams illustrating messages 700, 800, and 900 between a subscriber, an application marketplace platform, a third-party platform, and a third-party application. A subscriber shall refer to a user of the SP 102 of FIG. 1 that uses the application marketplace platform to purchase or subscribe to the third-party applications that are useable within the SP 102.

In particular, FIGS. 7-9 show messages to bill a subscriber based on the subscriber's profile within the application marketplace platform. For example, the serving platform serving as an e-commerce platform may designate certain users as “power sellers” based on a volume of sales within the e-commerce platform. In such a case, a third-party developer may define a billing plan that charges “casual sellers” one fee while “power sellers” are charged another fee.

FIG. 7 is a message diagram illustrating a series of messages 700 that enable a third-party platform 706 to charge a subscriber 702 based on user information stored within the SP 102, according to an example embodiment. FIG. 7 shows that the subscriber 702 subscribes to a third-party application 708 by sending a subscription message 710 to an application marketplace platform 704. The subscriber 702 may select to subscribe to a billing plan (see, e.g., FIG. 3, the billing plan 300), which may be provided by the third-party application 708.

Responsive to receiving the subscription message 710, the application marketplace platform 704 sends a message 712 to the third-party platform 706 indicating that the subscriber 702 is requesting to subscribe to the selected billing plan, as provided by third-party application 708. The message 712 may include an identification of the selected billing plan and an identification of the subscriber 702. In an example embodiment, the third-party platform 706 verifies those identifications and may determine that the subscriber 702 is authorized (e.g., permitted) to subscribe to the third-party application 708 according to the selected billing plan (e.g., that the subscriber 702 is in good standing, based on previous transactions, with the third-party developer). Based on successfully authorizing the subscriber 702, the third-party platform 706 may return an indication of approval to the application marketplace platform 704 that the subscriber 702 is authorized to subscribe to the third-party application 708.

Based on the approval from the application marketplace platform 704, the application marketplace platform 704 may create a sub-account under the user-account of the SP 102 belonging to the subscriber, according to message 714.

A third-party developer may define different types of billing plans. A billing plan may contain one or more fees rated (e.g., set or provided) by the billing system or one or more fees rated by the third party developer. In a subscription flow, a subscriber may select a billing plan (e.g., from among multiple billing plans presented to the subscriber). If the billing plan contains fees that are rated by the billing system, then the rate is predefined, and the billing system may calculate the fees. If a billing plan contains fees that are rated by the third party developer, then the rate may be determined by the third-party developer based on usage of the application or user attributes. If a fee is rated by the third party developer based on user attributes, then the billing rates may differ for different subscribers (e.g., a particular billing rate for low volume sellers and another billing rate for high volume sellers).

To determine an appropriate billing rate for the subscriber 702, the third-party platform 706 may send a message 716 requesting user information associated with the subscriber 702. Based on the user information, the third-party platform 706 may determine an appropriate billing rate for the subscriber 702 and pass the rate (e.g., via an API for usage data). For example, the user information may indicate that the subscriber 702 is a power seller. Accordingly, the third-party platform 706 may record subsequent usage fees or recurring fees based on a fee associated with the power seller. On the other hand, the user information may indicate that the subscriber 702 is a low volume seller and, as a result, should be charged at a different rate.

FIG. 7 shows that the subscriber 702 may operate or use the third-party application 708, as indicated by message 718. In response to the subscriber's use, the third-party application 708 may send the third-party platform 706 a message 722 to record a usage-based fee. Responsive to receiving the message 720 to record usage, the third-party platform 706 may determine the appropriate fee for the subscriber 702, based on a rate selected earlier in the message 716, and communicate the appropriate fee to the application marketplace platform 704 at message 722. The application marketplace platform 704 may store the fee under the sub-account (e.g., message 724), and bill the subscriber 702 at an appropriate time (e.g., immediately or based on a determinable period (e.g., monthly)).

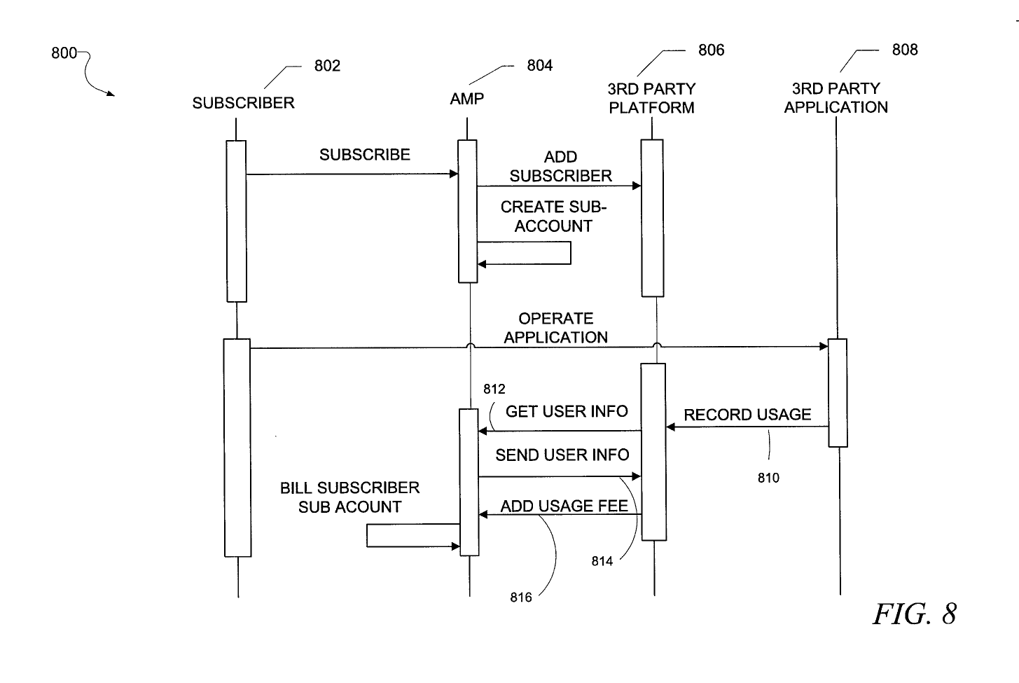

FIG. 8 shows an alternative approach to charging a subscriber 802 based on subscriber information stored in an application marketplace platform 804. Whereas the messages 700 of FIG. 7 determine a billing charge based on user information at the time the subscriber 702 of FIG. 7 subscribes to the third-party application 708, also of FIG. 7, messages 800 determine a billing charge after recording each use of a third-party application 808 by the subscriber 802. To illustrate, in response to a third-party application 808 sending a message 810 to record usage of the subscriber 802, a third-party platform 806 requests user information from the application marketplace platform 804 at message 812. Based on receiving the user information, at message 814, the third-party application 806 determines the appropriate rate for the subscriber's usage and then sends a message 816 to the application marketplace platform 804 to add a usage fee. This approach has the advantage of the third-party platform 806 automatically determining the appropriate fee even where the status of the subscriber 802 changes after the subscriber 802 has subscribed to the third-party application 808.

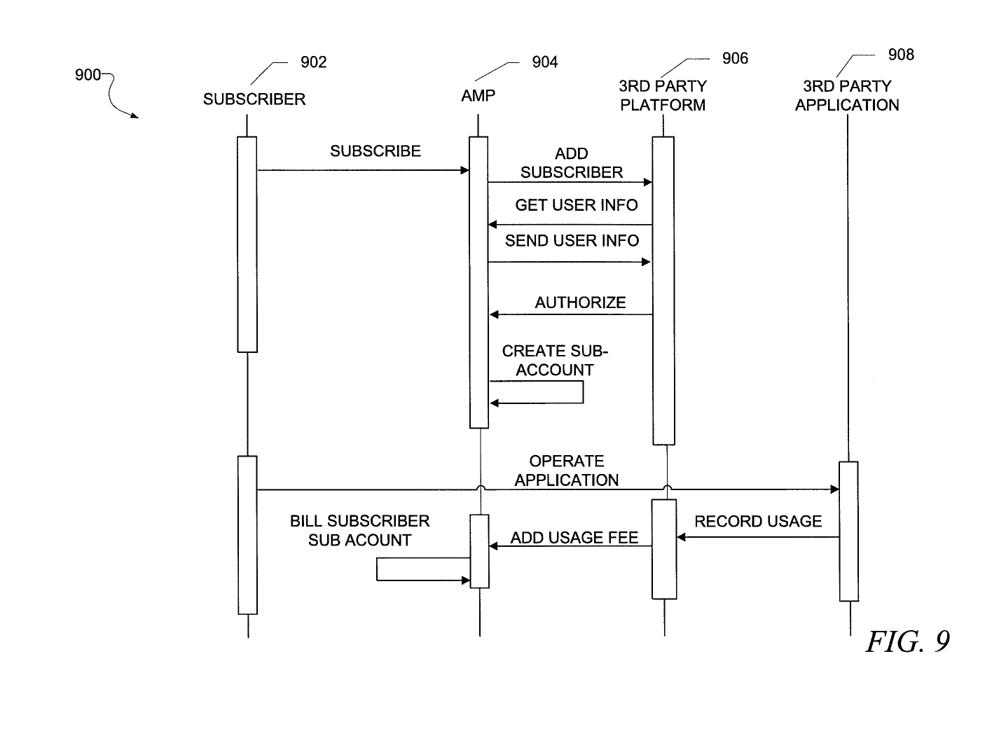

FIG. 9 shows yet another approach to charging the subscriber based on subscriber information stored in the application marketplace platform, according to some example embodiments. Compared to FIGS. 7 and 8, a third-party platform 906 in FIG. 9 authorizes a subscription based on user information (e.g., whether the subscriber qualifies as a power seller) stored in an application marketplace platform 904. In one example embodiment, a third-party application 908, in response to receiving a request from the application marketplace platform 904 to subscribe a subscriber 902 to a billing plan, requests user information corresponding to the subscriber 902 from the application marketplace platform 904. Consequently, a third-party platform 906 may determine whether the subscriber matches predefined requirements of the billing plan (e.g., the subscriber is a power seller). This approach allows the third-party developer to define a single billing plan that includes one or more use charges based on possible attributes of user information, rather than defining a plurality of billing plans, each billing plan defining a use charge for each possible attribute of user information.

Note that although the above specification describes billing related to a subscription model, other similar models may also be provided in example embodiments. For example, the application marketplace platform may allow one time purchase billing plans. Note also that the application marketplace platform may simply facilitate a transaction between the subscriber, third-party developer, and a financial institution. In this case, the application marketplace platform does not directly handle or is not responsible for the exchange of fees. The application marketplace platform may merely facilitate the payment processing. For example, the payment may be deducted from a primary payment account of a subscriber and be sent to an account belonging to a third party developer. In various example embodiments, a full payment for a usage charge may be collected prior to completion of the transaction. Alternatively, a full or partial payment may be collected as a one-time payment (e.g., initiated by the user) or as part of a regular payment cycle (e.g., monthly payments).

### Example Machine Architecture and Machine-Readable Medium

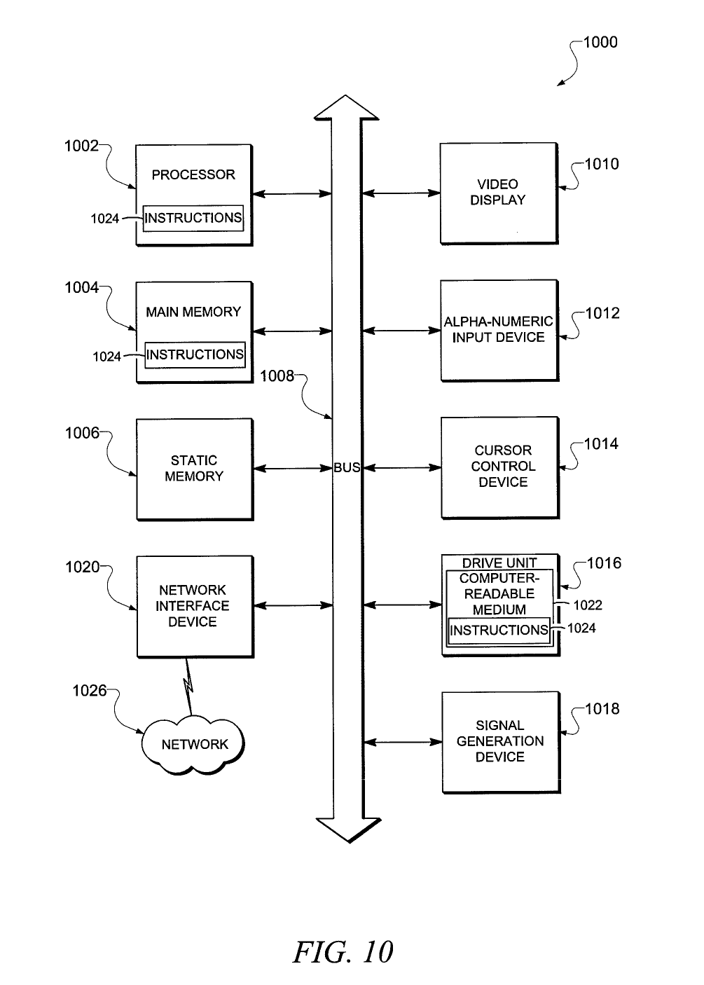

FIG. 10 is a block diagram of a machine in the example form of a computer system 1000 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or client devices in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Storage Medium

The disk drive unit 1016 includes a machine-readable storage medium 1022 on which is stored one or more sets of instructions 1024 and data structures (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable storage medium 1022 is shown in an example embodiment to be a single medium, the term “machine-readable storage medium” may include a single medium or multiple media (e.g., a centralized or distributed database, and/or associated caches and servers) that store the one or more instructions 1024 or data structures. The term “machine-readable storage medium” shall also be taken to include any tangible medium that is capable of storing, encoding or carrying instructions for execution by the machine and that causes the machine to perform any one or more of the methodologies of the present invention, or that is capable of storing, encoding or carrying data structures utilized by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. Moreover, the machine-readable storage medium may be a non-transitory machine-readable storage medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., Hypertext Transfer Protocol (HTTP)). Examples of communication networks include a local area network (LAN), a wide area network (WAN), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Modules, Components and Logic

Certain embodiments are described herein as including logic or a number of components, modules, or mechanisms (e.g., collectively referred to as “components” hereinafter). A component is a tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein

In various embodiments, a component may be implemented mechanically or electronically. For example, a component may comprise dedicated circuitry or logic that is permanently configured (e.g., as a special-purpose processor) to perform certain operations. A component may also comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software), may be driven by cost and time considerations.

Accordingly, the term “component” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components are temporarily configured (e.g., programmed), each of the components need not be configured or instantiated at any one instance in time. For example, where the components comprise a general-purpose processor configured using software, the general-purpose processor may be configured as respective different components at different times. Software may accordingly configure a processor, for example, to constitute a particular component at one instance of time and to constitute a different component at a different instance of time.

Components can provide information to, and receive information from, other components. Accordingly, the described components may be regarded as being communicatively coupled. Where multiples of such components exist contemporaneously, communications may be achieved through signal transmission (e.g., over appropriate circuits and buses) that connect the components. In embodiments in which multiple components are configured or instantiated at different times, communications between such components may be achieved, for example, through the storage and retrieval of information in memory structures to which the multiple components have access. For example, one component may perform an operation and store the output of that operation in a memory device to which it is communicatively coupled. A further component may then, at a later time, access the memory device to retrieve and process the stored output. Components may also initiate communications with input or output devices, and can operate on a resource (e.g., a collection of information).

Although certain specific example embodiments are described herein, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments are described and illustrated in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system, comprising:
an application module configured to store a third-party application deployed by an application marketplace platform;
a billing profile module configured to store a billing plan associated with the third-party application, the billing plan defining a fee to subscribe to the third-party application;
an account profile module configured to create, using one or more processors, a sub-account responsive to receiving a user request to subscribe to the third-party application according to the billing plan, the user request being received from a device of a user, the sub-account being a third-party application account linked to a user account of the user at the application marketplace platform; and
a billing module configured to facilitate a billing transaction between the sub-account and a developer account according to the fee defined by the billing plan.

2. The system of claim 1, wherein the billing plan further defines a usage fee that represents a cost to the user based on a use of the third-party application.

3. The system of claim 1, further comprising a usage module configured to receive usage information, from the third-party application, that represents a use of the third-party application by the user.

4. The system of claim 1, further comprising an application integration interface module configured to provide user information responsive to a request by a third-party platform associated with the third-party application, the user information to be used by the third-party application to determine an appropriate fee.

5. The system of claim 4, wherein the user information indicates the user is a high-volume seller.

6. The system of claim 1, further comprising an application integration interface module configured to provide user information to the third-party application, the user information to be used by the third-party application to authorize a request by the user to subscribe to the third-party application according to the billing plan.

7. The system of claim 1, further comprising a billing plan vetting module configured to authorize the billing plan, and, responsive to the authorizing of the billing plan, to configure the billing plan.

8. A computer-implemented method comprising:
deploying a third-party application from an application marketplace platform;
storing a billing plan associated with the third-party application, the billing plan defining a fee to subscribe to the third-party application;
creating, using one or more processors of a machine, a sub-account responsive to receiving a user request to subscribe to the third-party application according to the billing plan, the user request being received from a device of a user, the sub-account being a third-party application account linked to a user account of the user at the application marketplace platform; and
facilitating a billing transaction between the sub-account and a developer account according to the fee defined by the billing plan.

9. The computer-implemented method of claim 8, wherein the billing plan further defines a usage fee that represents a cost to the user based on a use of the third-party application.

10. The computer-implemented method of claim 8, further comprising receiving usage information, from the third-party application, that represents a use of the third-party application by the user.

11. The computer-implemented method of claim 8, further comprising providing user information to a third-party platform associated with the third-party application responsive to receiving a request from the third-party platform, the user information to be used by the third-party application to determine an appropriate fee.

12. The computer-implemented method of claim 11, wherein the user information indicates the user is a high-volume seller.

13. The computer-implemented method of claim 8, further comprising providing user information to a third-party platform, the user information to be used by the third-party platform to authorize the user subscribing to the billing plan.

14. The computer-implemented method of claim 8, further comprising:
authorizing the billing plan based on a policy; and
configuring the billing plan responsive to authorization of the billing plan.

15. A non-transitory machine-readable storage medium comprising instructions that, when executed by one or more processors of a machine, causes the machine to perform operations comprising:
deploying a third-party application from an application marketplace platform;
storing a billing plan associated with the third-party application, the billing plan defining a fee to subscribe to the third-party application;
creating a sub-account responsive to receiving a user request to subscribe to the third-party application according to the billing plan, the user request being received from a device of a user, the sub-account being a third-party application account linked to a user account of the user at the application marketplace platform; and
facilitating a billing transaction between the sub-account and a developer account according to the fee defined by the billing plan.

16. The non-transitory machine-readable storage medium of claim 15, wherein the billing plan further defines a usage fee that represents a cost to the user based on a use of the third-party application.

17. The non-transitory machine-readable storage medium of claim 15, wherein the operations further comprise receiving usage information from the third-party application, the usage information representing a use of the third-party application by the user.

18. The non-transitory machine-readable storage medium of claim 15, wherein the operations further comprise providing user information to a third-party platform associated with the third-party application responsive to receiving a request, the user information being usable by the third-party application to determine an appropriate fee.

19. The non-transitory machine-readable storage medium of claim 15, wherein the user information indicates that the user is a high-volume seller.

20. The non-transitory machine-readable storage medium of claim 19, wherein the operations further comprise providing user information to a third-party platform, the user information being usable by the third-party platform to authorize a user subscribing to the billing plan.

21. The non-transitory machine-readable storage medium of claim 15, wherein the operations further comprise receiving the billing plan, as submitted by the third-party application, and authorizing the billing plan based on a set of policies.
